(19) United States
(12) Patent Application Publication
(10) Pub. No.: US 2015/0232583 A1
(43) Pub. Date: Aug. 20, 2015

(54) PROCESSES AND METHODS FOR EXTRACTING RUBBER FROM GUAYULE

(71) Applicant: PANARIDUS, Casa Grande, AZ (US)

(72) Inventors: Michael R. Fraley, Casa Grande, AZ (US); Lauren Johnson, Casa Grande, AZ (US)

(73) Assignee: PANARIDUS, Casa Grande, AZ (US)

(21) Appl. No.: 14/429,297

(22) PCT Filed: Sep. 18, 2013
(86) PCT No.: PCT/US2013/060401

§ 371 Date: Mar. 18, 2015

Related U.S. Application Data
(60) Provisional application No. 61/702,741, filed on Sep. 18, 2012.

(51) Int. Cl. C08C 1/02; B01D 11/02

(52) U.S. Cl. CPC C08C 1/02; B01D 11/02

(57) ABSTRACT

Improved methods and processes of extracting rubber from guayule and guayule-like fibrous plant material are disclosed herein in. The methods and process advantageously may include the step of drying the plant material to a moisture content of about 18% to about 36% to produce a feedstock, performing at least a first grind of the feedstock, optionally adding an antioxidant to the feedstock, combining an extraction solvent with the feedstock after the antioxidant has been added to the feedstock to form a miscella, and recovering rubber from the miscella.

### CROSS-REFERENCE TO RELATED APPLICATIONS

The present application claims the benefit of U.S. Provisional Application No. 61/702,741 filed on Sep. 18, 2012, the content of which is hereby incorporated by reference in its entirety.

### FIELD OF THE INVENTION

This invention relates to methods of extracting quality rubber from Parthenium argentatum, commonly known as the guayule, to increase rubber quantity, quality, and usability.

### BACKGROUND

Natural rubber consumption in the United States is largely derived from the plant Hevea brasiliensis. Historically, over 90% of the Hevea-derived natural rubber imported by the United States originates in Indonesia, Malaysia and Thailand. Natural rubber from guayule can be grown in southwestern United States and also northern Mexico. More efficient and effective methods of extracting rubber from guayule that result in higher rubber quantity, quality, and usability would make guayule more competitive with imported Hevea-derived rubber.

### SUMMARY OF THE INVENTION

According to one aspect, a method of extracting rubber from guayule and guayule-like fibrous plant material comprises drying the plant material to a moisture content of about 18% to about 36% to produce a feedstock, performing at least a first grind of the feedstock, combining an extraction solvent with the feedstock after the antioxidant has been added to the feedstock to form a miscella, and recovering rubber from the miscella.

Various implementations and embodiments of a method for extracting rubber from guayule and guayule-like fibrous plant material may comprise one or more of the following. Adding an antioxidant to the feedstock. Harvesting the plant material to produce a feedstock, performing at least a first grind of the feedstock, adding an antioxidant to the feedstock, combining an extraction solvent with the feedstock after the antioxidant has been added to the feedstock to form a miscella, and recovering rubber from the miscella. The plant material may be dried to a moisture content of about 18% to about 36%. The step of recovering rubber from the miscella may comprise setting the miscella for a period of dwell time of at least about 2 to about 6 hours. The step of recovering rubber from the miscella may further comprise applying heat to the miscella. The step of recovering rubber from the miscella may further comprise forming a plant material free miscella comprising the extraction solvent, an amount of rubber and an amount of resin and concentrating the plant material free miscella to less than the original volume by evaporating the extraction solvent, and adding additional acetone to precipitate rubber. The plant material may be dried to a moisture content of between about 28%-36%; more preferably between about 30%-36%. The at least first grind may comprise a first grind performed using a first grind ⅜ inch screen and at least a second grind. The second grind may be performed using a second grind ⅜ inch or smaller screen and the period of dwell time is 2 to 4 hours. The second grind may be performed using a second grind ⅛ inch or smaller screen. The antioxidant may be added before the at least first grind. The antioxidant may be added before a second grind and after a chopping step, wherein the feedstock is cut into pieces prior to grinding. The plant material free miscella may be concentrated to about half the original volume. The antioxidant may be added to the feedstock at a rate of between 2 and 4 parts antioxidant per hundred parts of expected rubber. The antioxidant comprises a phenylenediamine, optionally a dithiocarbamate is added or combination thereof. The antioxidant may comprise at least SANTOFLEX 134. BUTYL ZYMATE may be added at between 0.01 part per hundred to about 0.1 part per hundred. The heat applied to the miscella may be between 28° C. and 49° C.; more preferably between 30° C. and 48° C.; and most preferably between 37° C. and 46° C. The extraction solvent may be pentane acetone. The extraction solvent may be in a ratio of about 76 to 82 parts pentane to 17 to 24 parts acetone by weight, most preferably about 79 parts pentane and about 21 parts acetone. The rubber extracted may have a molecular weight of at least 1,700,000. The rubber extracted may have a molecular weight of at least 2,000,000. The rubber extracted may have a molecular weight of at least 2,500,000.

According to another aspect, an extracted guayule rubber comprises a molecular weight of at least 1.7 million (M) grams/mole, volatiles of less than about 0.30%, and a plastic retention index (PRI) of at least about 38.

Various implementations and embodiments of the extracted guayule rubber comprise one or more of the following. The molecular weight may be at least 2.0M grams/mole, more preferably at least 2.25M grams/mole, and most preferably at least 2.5M grams/mole. The volatiles may comprise less than about 0.25%, more preferably less about 0.20%, and most preferably less than about 0.17%. The PRI may be at least 40, more preferably at least 55, and most preferably at least 70. The extracted guayule rubber may comprise an unvulcanized original plasticity value of at least 30. The extracted guayule rubber may comprise a Mooney unit of at least 55, more preferably at least 70, and most preferably at least 75. The extracted guayule rubber may be a nonallergenic or hypoallergenic guayule rubber. The extracted rubber may be extracted through an extraction process that comprises drying guayule plant material to a moisture level of about 30% to about 36%. The extraction process may comprise performing a first grind through a ⅜ inch screen. The extraction process may comprise performing a second grind through a ⅜ inch or smaller screen. Performing a second grind may comprise performing a second grind through a ⅛ inch or smaller screen. The extraction process may comprise adding an antioxidant to the feedstock before performing the second grind. The extraction process may comprise adding an antioxidant to the feedstock before performing the first grind. The extraction process may comprise combining an extraction solvent with the feedstock after the antioxidant has been added to the feedstock to form a miscella. The extraction process may comprise recovering rubber from the miscella.

The foregoing and other aspects, features, and advantages will be apparent to those artisans of ordinary skill in the art from the DESCRIPTION and from the CLAIMS.

### DETAILED DESCRIPTION OF THE INVENTION

Aspects and applications of the invention presented here are described below in the detailed description of the invention. Unless specifically noted, it is intended that the words and phrases in the specification and the claims be given their plain, ordinary, and accustomed meaning to those of ordinary skill in the applicable arts.

In particular aspects, methods and processes useful for increasing the total amount or quantity of rubber, as well as the quality of rubber, extracted from guayule are disclosed herein. Various embodiments further provide techniques for optimizing postharvest, pre-extraction to increase rubber quantity, quality, and usability.

The molecular weights (MW) of rubber range from 50,000 to 3,000,000. Generally, rubber having a lower molecular weight is less desirable because the lower molecular weight rubber is characterized as having less stiffness, strength, viscoelasticity, toughness, and viscosity. Thus, lower molecular weight rubber because it does not have the physical properties sufficient to bear design loads.

### Post Harvest (Pre-Extraction)

According to embodiments described herein various postharvest (pre-extraction) methods and processes are used to increase the rubber quality and value, as well as the efficiency of the rubber extraction.

### Moisture Content

In one or more embodiments, a method of extracting rubber from guayule and guayule-like fibrous plant material comprises drying the plant material to make a feedstock. Contrary to previous teachings it is shown herein that higher moisture levels (relative to the prior art) are beneficial. According to various aspects, the plant material is preferably dried to a moisture content of about 18% to about 36%, more preferably to about 21% to about 36%; or most preferably to about 28%-34%. Alternatively, the plant material is preferably dried to a moisture content of approximately 26% to approximately 32%. In other embodiments, the plant material is preferably dried to a moisture content of approximately 30% to approximately 36%.

In a particular, non-limiting example, it was discovered that feedstock kept at 13.4% or higher moisture level achieved a molecular weight of 1,539,857. Additionally, further testing showed that the same feedstock exposed to additional drying at room temperature in open air reduced the moisture level down to 11.44%, which resulted in an average molecular weight of only 382,600 units. Such levels result in a significantly lower quality of rubber.

Table 1 provides results from a series of bench-top trials of rubber extraction from guayule plants. As listed, the bench-top trials include a description of the plant tested, any additional treatments, the percent moisture as sent from the lab (PA) and as tested by the United States Department of Agriculture (USDA), the percent rubber, and the molecular weight from the extraction. From these bench-top trials, it was determined that the molecular weight of the extracted rubber was affected by moisture concentrations of the feedstock.

TABLE 1
Data from the Series I Bench-Top Trials

| | | | | | % Rubber | | MW/Mn |
|---|---|---|---|---|---|---|---|
| | | | | | with | MW from | from |
| | | | % Moisture | % Moisture | Pentane: | Pentane: | Pentane: |
| Sample | | Additional | as Sent | as Tested by | Acetone | Acetone | Acetone |
| I.D. | Description | Treatment | from PA | USDA | Extraction | Extraction | Extraction |
| P33, 34 | 2X Ground | | 3 | <1 | 0.28 | 520,650 | 2.20 |
| | Shrub Upright | | | | | | |
| | Stanfield | | | | | | |
| P37, 38 | 2X Ground | added water | 3 | 9.9 | 0.19 | 233,100 | 1.47 |
| | Shrub Upright | up to 10% | | | | | |
| | Stanfield | moisture | | | | | |
| P39.40 | 2X Ground | | 9 | 6.8 | 1.35 | 1,028,150 | 3.21 |
| | Shrub Upright | | | | | | |
| | Stanfield | | | | | | |
| P51, 2 | 2X Ground | | 19 | 15.0 | 0.68 | 1,475,500 | 2.35 |
| | Shrub Upright | | | | | | |
| | Stanfield | | | | | | |
| P48, 9, 0 | 2X Ground | | 23 | 21.2 | 0.69 | 1,508,667 | 2.30 |
| | Shrub Upright | | | | | | |
| | Stanfield | | | | | | |
| P45, 6, 7 | 2X Ground | | 32 | 28.6 | 0.50 | 1,384,333 | 2.27 |
| | Shrub Upright | | | | | | |
| | Stanfield | | | | | | |

Table 2 provides results from a series of larger scale (25 liter) trials of rubber extraction from guayule plants. As listed, the batch trials include a batch trial series identification (ID) name, number of runs within the series, the average percent moisture for all individual tests within a series, the range of percent moisture for the individual tests within a series, the average molecular weight for each series, the average initial plasticity (Po), the average plasticity retentive index (PRI), and average extraction efficiency. The variation in moisture within each series is due to a drop in moistures over time in the storage bags that were not completely sealed against moisture loss.

TABLE 2
Data From a Series of Batch Trials

| | Number | | | | | | |
|---|---|---|---|---|---|---|---|
| | of | | | MW from | | | |
| | Individual | Average | % | Pentane: | | | |
| | Trials in | % | Moisture | Acetone | | | Extraction |
| Series ID | the Series | Moisture | Range | Extraction | Po | PRI | Efficiency |
| UNR1 | average | 21% | 19-24% | 1,724,333 | 32.6 | 25.1 | 34% |
| | of 15 trials | | | | | | |
| UNR2 | average | 30% | 27-36% | 2,007,800 | 41.8 | 39.1 | 51% |
| | of 5 trials | | | | | | |
| UNR3 | average | 36% | 35-37% | 2,149,556 | 36.4 | 46.9 | 65% |
| | of 7 trials | | | | | | |
| UNR4 | average | 35% | 34-37% | 2,080,746 | 36.0 | 59.0 | 54% |
| | of 7 trials | | | | | | |
| UNR5 | average | 36% | 33-38% | 2,212,750 | 38.1 | 34.4 | 54% |
| | of 4 trials | | | | | | |
| UNR6 | average | 29% | 28-30% | 2,081,500 | 44.7 | 44.0 | 33% |
| | of 4 trials | | | | | | |

From these six series of batch runs, three trends related to moisture levels were observed. First, the relationship of molecular weight and moisture continues similarly to the bench top trials. UNR1 had lower moisture (21%) and lower average molecular weight (1,724,333). The remaining series (UN2 through UNR6) seemed to have reached a peak molecular weight between 2 and 2.2 million once a shrub moisture concentration of approximately 30% or greater was reached.

Second, the initial plasticity (Po) was significantly greater in UNR2 through UNR6 when compared to UNR1. For example, UNR1 had an average moisture level of 21% and an average Po of 32.6. Subsequently, higher moisture runs (UNR2 through UNR6), which seemed to have reached a peak for MW, had an overall average Po of 39.4

And third, a loss of extraction efficiency occurs when the moisture level falls below 30%. For example, a noticeably smaller amount of rubber can be extracted below approximately 30% moisture level as compared to a moisture level of 30% and above. Therefore, according to various embodiments, it was discovered that good results are achieved when moisture levels are kept between approximately 20% and approximately 37%, more preferably between approximately 28% and approximately 37%, or most preferably between approximately 30% and approximately 37%. Under certain conditions these ranges may expand to include optimal efficiency at a lower percentage of moisture level.

### Grinding Size

In one or more embodiments, a method of extracting rubber from guayule and guayule-like fibrous plant material comprises grinding the feedstock. Grinding the feedstock typically comprises one, two, three, four, or five or more grinds. Each grind is performed to further reduce the size of the feedstock in particular embodiments. For example, the first grind may be performed using a ⅜ inch grind screen and the second grind may be performed using a ⅜ inch grind screen or a smaller, ⅛ inch screen, and so on.

Testing data was obtained in order to consider the effect of grind size on the molecular weight of the rubber. A first treatment comprised a one-time pass through a ⅜ inch screen. In one or more embodiments, a chipper (such as but not limited to an Echo Bearcat Chipper) grinds the feedstock in a grinding chamber. The grinding chamber comprises a screen with ⅜ inch holes extending therethrough to prevent passage of feedstock larger than ⅜ inch. A second treatment comprised a two-time pass through a grinding chamber with a ⅜ inch screen.

A third treatment comprised a one-time pass through a grinding chamber comprising a ⅜ inch screen and a one-time pass through a grinding chamber comprising a ⅛ inch screen. Grinding the feedstock through a ⅛ screen is, according to one aspect, accomplished using a Colorado Milling Equipment (CME) hammer mill model HMS. Other embodiments may comprise any grinding or chipping machine known in the art. The ⅛ inch screen comprises numerous ⅛ inch holes to keep the feedstock in the milling or grinding chamber until it is fine enough to pass through a ⅛ inch hole.

It was observed that extraction efficiencies improved with additional grinding. The total grams (g) of rubber extracted per run were: 43 g extracted from the first treatment; 54 g extracted from the second treatment; and 74 g extracted from the third treatment. This was from feedstock that had a total of 215 g of rubber per run. Thus, according to various embodiments included herein, improved extraction efficiencies are achieved with the finest grind. Other embodiments may comprise grinding the feedstock to pass through smaller screens, such as but not limited to 3/32 inch or 1/16 inch screens. Use of these 3/32 inch or 1/16 inch screens may be in combination with the passes through the ⅜ inch and ⅛ inch screens as described above.

### Anti-Oxidants

It is understood that antioxidants protect natural rubber from degradation due to heat and oxidation. Antioxidants, however, are conventionally added and applied at the time the rubber is precipitated from the solvent mixture. Our test data has shown conclusively that molecular weight starts to degrade even within a few hours if an antioxidant is not added. It is shown that molecular weight has dropped from normal (1.5 million plus) to well below a million within only a few hours.

In one or more embodiments, a method of extracting rubber from guayule and guayule-like fibrous plant material comprises adding an antioxidant to the feedstock. Adding the antioxidant to the feedstock may occur at different times according to different embodiments. According to various embodiments, antioxidants are added to the feedstock before adding an extraction solvent. More specifically, antioxidants are added to the feedstock before the last grind and adding the extraction solvent. For example, the antioxidant may be added to the feed stock before the first grind or at least before a final grind, such as between a first grind and second grind. The antioxidants may alternatively or additionally be added after a chopping step, wherein the feedstock is cut into pieces, but prior to a grind. This contrasts conventional extraction methods in which antioxidants are added and/or applied at the time the rubber is precipitated from the solvent mixture.

The antioxidants may comprise but are not limited to a phenylenediamine, dithiocarbamate or combination thereof. In a particular embodiment, the antioxidant comprises at least SANTOFLEX 134 and/or BUTYL ZYMATE. When a phenylenediamine is used it is preferably added to the feedstock a rate of between approximately 1 and 10 parts antioxidant per hundred parts of expected rubber; and more preferably at 10 parts antioxidant per hundred parts of expected rubber. When BUTYL ZYMATE is added, however, it is added to the feedstock preferably at between 0.01 part per hundred parts of expected rubber to about 0.1 part per hundred parts of expected rubber. In other embodiments, a mixture of two kinds of para-phenylenediamines (PPDs) may be readily used. In still other embodiments, any rubber antioxidants in the phenolics and amines principal classes may be utilized. Examples of amine types include but are not limited to the substituted diphenylamines, para-phenylenediamines (PPD, where R,R′=alkyl or aryl), and polymeric trimethyl-dihydroquinoline (TMQ).

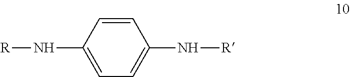

As described earlier, a zinc dibutyldithiocarbamate can be used, but at much lower amounts.

In measuring plasticity, Po stands for original plasticity. The Po value is determined by a test called the Wallace Plasticity Test. In this test, equipment measures the displacement of plates pressing on a precut and sized piece of unvulcanized (uncured) natural rubber. This measures the plasticity (viscosity) of the rubber. The more the natural rubber flows, the closer together the plates will be after a certain amount of time and force, resulting in a smaller Po value.

In further measuring plasticity, PRI is the plasticity retention index. More specifically, PRI is the ratio of the Po with the plasticity after aging. If the plasticity after aging is 40% of the Po, then the PRI is 40. Technically specified rubber (TSR) 20 and TSR 10 standards for Po are 30, while TSR 20 and TSR 10 standards for PRI are 40 and 50, respectively (TSR 10 is a higher grade natural rubber).

In the first larger series of batch runs labeled UNR1 in Table 2, antioxidants were added at the rate of 2 parts per hundred (pph) of expected rubber at the precipitation phase. Under these runs it was shown that the molecular weights averaged at 1,724,333. Initial plasticity Po was 32.6, while after aging plasticity (Pa) was at 8.3. The plasticity retention index (PRI) was shown to be at 25.

In subsequent batch runs, labeled UNR2 through UNR6 in Table 2, antioxidants were added at a rate of 4 pph (4 parts antioxidant per 100 parts expected rubber) at the precipitation phase. In addition, enough antioxidants were added to the feedstock between the ⅜ and the ⅛ inch grind to equal what was expected to be 10% of the rubber that was available in that shrub. The molecular weights averaged 2,106,470, with an initial plasticity (Po) at 39.4, and a plasticity (Pa) of 17.5 after aging. The plasticity retention index (PRI) was at 44.7. This result represents a significant improvement.

In summary, it was discovered that adding antioxidant before adding extraction solvents protects the rubber during grinding and results in higher quality rubber. Additionally, higher levels of antioxidant are shown to be beneficial during these steps.

### Extraction Recipes and Procedures

### Solvent Identification and Ratios

In one or more embodiments, a method of extracting rubber from guayule and guayule-like fibrous plant material comprises combining an extraction solvent with the feedstock to form a miscella and recovering rubber from the miscella. In a specific preferred embodiment, the extraction solvent is a pentane acetone solvent, typically in a ratio of about 76 to 82 parts pentane to 17 to 24 parts acetone by weight, or more particularly about 79 parts pentane and about 21 parts acetone. This solvent mixture is known in the arts as appropriate. Additionally, hexane acetone in the same ratio is considered an acceptable solvent as well, even though it is not at an azeotrope at that ratio. Pure hexane or pure pentane is considered less appropriate in the arts. Bench-top testing has not shown any consistent advantage in any particular way.

### Dwell Times

In one or more embodiments, a method of extracting rubber from guayule and guayule-like fibrous plant material comprises recovering the rubber from the extract. Recovering the rubber may comprise allowing the mixture to sit for a period of dwell time. The dwell time is typically understood to be the time of interaction between the solvent and the ground feedstock. The appropriate dwell time varies significantly based on grind size, solvent extraction temperature, and the mechanism of how the solvent and the feedstock interact (e.g. batch versus continuous feed, reverse flow versus bath, etc.) In some embodiments, the dwell time comprises at least about 2 to about 6 hours or, more particularly, about 3 to 4 hours, e.g., 2.5 to 5 hours.

In one non-limiting example, a large extraction run was performed with a solvent extraction equipment provider and 30 minutes of dwell time in a reverse flow continuous extractor. In a reverse flow continuous extract, feedstock flows in a direction opposite the flow of the solvent. In other test bench-top extractions were performed using one hour of dwell time, in the large batch equipment. In still other embodiments, extraction tests were performed at 30 minutes, one hour, two hours, three hours, and four hours.

Data for the pentane/acetone solvent extractions are shown below in Table 3. Specifically, the time in minutes, the amount of rubber extracted in grams per liter of solvent, and the molecular weight of the corresponding rubber is presented. This data suggests that acceptable molecular weight rubber may be extracted at various dwell times. Dwell time should, therefore, be optimized based on extraction efficiency. In this case with the conditions present in this study, the most rubber was extracted at the longest time of 240 minutes.

TABLE 3
Dwell Time Study

| | Grams of rubber | |
|---|---|---|
| Time in minutes | per liter of solution | Molecular weight |
| 30 | 1.653 | 1,900,000 |
| 60 | 2.868 | 1,732,000 |
| 120 | 3.214 | 1,735,000 |
| 180 | 4.933 | 1,497,000 |
| 240 | 5.887 | 1,677,000 |

### Heat Applied During Extraction

Various temperatures may be applied during extraction. Pentane acetone azeotrope boils at 32° C., pentane boils at 36° C., and acetone boils at 56.2° C. According to various embodiments of the invention, a pressurized vessel is needed to bring the temperature to 50° C. In a particular, non-limiting embodiment, the pressurized vessel comprises an Eden Labs 25 gallon Coldfinger model. This pressurized vessel is a double walled vessel, with heated water between wall one and wall two that heats the solvent (miscella) within the inner wall of the vessel. In other embodiments, other pressurized vessels known in the art may be used.

With water heated to 45° C., the solvent (miscella) temperature varied between 28° C. and 49° C., with corresponding pressures of 4 to 19 pounds per square inch (PSI) (28 to 230 kPa. It was herein discovered, however, that lower temperatures provided superior quality rubber while not changing rubber quantity. For example, the temperature of the solvent during extraction is preferably between approximately 28° C. and 49° C. More preferably, the temperature of the solvent during extraction may be between approximately 30° C. and 48° C. Even more preferably, the temperature of the solvent during extraction may be between approximately 35° C. and 44° C.; e.g., 36° C., 37° C., 39° C., and 41° C.

In one or more embodiments, the temperature applied during extraction and the dwell time are controlled independently of one another. Interaction between the dwell time and the temperature applied during extraction may impact the over extraction efficiency.

### Reduction Ratios

In one or more embodiments, a method of extracting rubber from guayule and guayule-like fibrous plant material comprises recovering the rubber. Recovering the rubber further comprises forming a plant material-free miscella in various embodiments. The miscella typically comprises the extraction solvent, an amount of rubber, and an amount of resin.

Once the plant material-free (or feedstock free) miscella is recovered, it is concentrated using a rotary evaporator or any other suitable evaporator known in the art. The evaporated solvent is typically recovered through distillation. Thus, one or more embodiments may further comprise concentrating the plant material-free miscella to less than the original volume by evaporating the extraction solvent and adding additional acetone to precipitate rubber. Preferably the plant material-free miscella is concentrated to about half the original volume. This improves the efficiency of rubber precipitation and minimizes the quantity of pure acetone needed for precipitation. A reduction from 100% to 50% of the original volume is considered a good starting point. Table 4 presents results of tests comprising a reduction to 50%, 35%, 25% and 10%. A reduction to below 25% is relatively viscous, making it difficult to handle. The most preferred results were at the 50% reduction.

TABLE 4
Reduction Ratio Study

| Volume reduction | | |
|---|---|---|
| from an original 1000 mls | g rubber per liter of solution | MW |
| 100 (10%) | 3.866 | 1,561,000 |
| 250 (25%) | 3.612 | 1,721,000 |
| 350 (35%) | 4.76 | 1,570,000 |
| 500 (50%) | 5.887 | 1,677,000 |

### Precipitation Ratios

In one or more embodiments, a method of extracting rubber from guayule and guayule-like fibrous plant material comprises adding additional acetone after the miscella is concentrated to precipitate the rubber. In other embodiments, methanol is used. According to various preferred embodiments, a 1:1 ratio of concentrated miscella to additional solvent is used to precipitate the rubber. For example, for 500 mls of concentrated miscella, 500 mls of acetone would be added. This combination is then typically allowed to sit for a period of time, such as but not limited to between 1 and 20 minutes, or more preferably between 5 and 15 minutes, or most preferably approximately 10 minutes. Alternatively, the combination may sit for approximately 5 minutes. The mixture may be lightly stirred on occasion as it sits.

In other embodiments, different rations of concentrated miscella to additional solvent may be utilized. Table 5 provides four non-limiting exemplary ratios of 0.25:1.0, 0.5:1.0, 0.75:1.0 and 1.0:1.0. The test data presented in Table 5 indicates that lower levels of added acetone typically result in less rubber with a higher molecular weight precipitating. Accordingly higher amounts of rubber precipitate resulted from adding more acetone. Conversely, the molecular weight was not reduced with more acetone as expected. Thus, a 1:1 ratio may be preferred in various embodiments.

TABLE 5
Miscella to Solvent Ratios and Results

| mls acetone added per | g rubber | |
|---|---|---|
| 100 mls miscella | per liter of solution | molecular weight |
| 25 | 4.85 | 1,696,000 |
| 50 | 4.5 | 1,564,000 |
| 75 | 4.305 | 1,625,000 |
| 100 | 5.887 | 1,677,000 |

Table 6 provides a non-limiting example of characteristics of rubber extracted from a guayule plant using one or more of the embodiments described herein. Table 6 presents the percentage of dirt of each sample. According to one aspect, dirt is foreign material or retains that do not pass through a #325 (45 micron) mesh sieve. A known initial weight of rubber, from 10 to 12 grams, is solubilized with xylene at 130° C. for 3 hours, with the aid of a small amount of peptizer, and sieved. The retained material is then dried and weighed. Dirt is reported as a percentage of the initial rubber weight (ASTM D 1278 section 9 through 13).

Table 6 also presents the percentage of ash of each sample. According to one aspect, ash is the percentage of mineral that is left after the rubber is oxidized in a crucible. If there is very fine mineral matter too small to be retained on a #325 sieve, the ash test will find it. A known initial weight of rubber, from 5 to 6 grams, is placed in a crucible in an oven at 550° C. until all carbon is gone. The remaining ash is weighed. Ash is reported as a percentage of the initial rubber weight (ASTM D 1278 sections 14 through 16).

Table 6 also presents the percentage of volatiles of each sample. According to one aspect, this is the percentage of the rubber that is volatilized at 100° C. Ten to 12 grams of rubber is milled with a clearance set at 0.5 mm, or cut into very slender strips, to facilitate volatilization. The resulting rubber sample is placed in a forced air oven at 100° C. until the mass is constant. Volatiles are measured as the percentage of reduction in weight of the rubber (ASTM D 1278 Sections 6 through 8).

Table 6 also presents the Po of each sample. The Po may be determined as previously described through the Wallace Plasticity Test (ASTM D 3194-99), which measures the plasticity of the rubber. The PRI presented in Table 6 is determined as previously described.

Table 6 also presents the viscosity of the uncured rubber, as determined by Mooney viscosity (ASTM D 1646). Mooney viscosity is measured by a Mooney viscometer and is defined as the torque of the instrument's rotating spindle within heated dies. A lower torque required to rotate the spindles in the heated rubber sample is interpreted as meaning that the uncured rubber comprises a lower viscosity. The Mooney viscosity reported in Table 6 is reported in Mooney units.

Table 6 also reports the molecular weight of the each sample. The molecular weight is typically measured using gel permeation chromatography (GPC). This form of chromatography utilizes size exclusion. Separation occurs through a column packed with porous beads. Smaller analytes spend more time in the pores and thus pass through the column more slowly. A detector measures the amount of polymer in the elution solvent as it is eluted. The molecular weight reported is the weighted average molecular weight.

In a particular, non-limiting embodiment, approximately 3 mg of a dried rubber sample was solubilized in 3 mL of tetrahydrofuran (THF) overnight with gentle shaking (such as a multi-purpose rotator). The rubber solution was then syringe-filtered through a 1.6 micrometer glass microfiber GF/A filter, and then injected into a high-performance liquid chromatography (HPLC) apparatus. Size exclusion occurs, separated by two Agilent PL gel 10 micrometer mixed-B columns in series and coupled to (1) a multi-angle laser light scattering detector, (2) a refractive index detector, and (3) an ultraviolet detector. In other embodiments, the molecular weight may be determined through any other suitable method, mechanisms, or apparatuses known in the art.

TABLE 6
Example Extraction Results

| | | | | | | Mooney | |
|---|---|---|---|---|---|---|---|
| | | | | | | ASTM D | |
| | Dirt | Ash | Volatiles | | | 1646 | MW |
| Sample | % | % | % | Po | PRI | (viscosity) | (g/Mol) |
| UNR1 | 0.89 | 0.11 | 0.19 | 27 | 22.2 | 59.8 | 1,540,000 |
| UNR2 | 0.17 | 0.06 | 0.17 | 40.5 | 39.5 | 78.5 | 1,440,000 |
| UNR3 | 0.20 | 0.02 | 0.31 | 37.5 | 54.7 | 73.3 | 2,010,000 |
| UNR4 | 0.88 | 0.06 | 0.03 | 37.5 | 60 | 73 | 1,860,000 |

In one or more embodiments, a method advantageously and preferably yields rubber having a molecular weight of at least 1,700,000, more preferably at least 2,000,000, and most preferably at least 2,500,000. This method also yields rubber having a Po of at least 30 and more preferably 40. This method also yields rubber having a PIR of at least 40, and more preferably 50, and most preferably yet 60. This method also yields rubber having a Mooney viscosity of at least 60 and preferably 70.

In one or more embodiments, the rubber extracted from the guayule plant comprises a non-allergenic or hypoallergenic rubber. This rubber is highly advantageous over conventional Hevea-derived natural rubber, which typically contains significant amounts of latex allergens. Guayule-derived rubber, however, typically lacks or has a low concentration of the protein allergens common in Hevea-derived natural rubber.

1. A method of extracting rubber from guayule and guayule-like fibrous plant material, comprising:
drying the plant material to a moisture content of about 18% to about 36% to produce a feedstock;
performing at least a first grind of the feedstock;
combining an extraction solvent with the feedstock after the antioxidant has been added to the feedstock to form a miscella; and
recovering rubber from the miscella.

2. The method of claim 1, further comprising adding an antioxidant to the feedstock.

3. A method of extracting rubber from guayule and guayule-like fibrous plant material, comprising:
harvesting the plant material to produce a feedstock;
performing at least a first grind of the feedstock;
adding an antioxidant to the feedstock;
combining an extraction solvent with the feedstock after the antioxidant has been added to the feedstock to form a miscella; and
recovering rubber from the miscella.

4. The method of claim 3, wherein the plant material is dried to a moisture content of about 18% to about 36%.

5. The method of claim 1, wherein the step of recovering rubber from the miscella comprises setting the miscella for a period of dwell time of at least about 2 to about 6 hours and the step of recovering rubber from the miscella further comprises applying heat to the miscella.

6. (canceled)

7. The method of claim 1, wherein the step of recovering rubber from the miscella further comprises: forming a plant material free miscella comprising the extraction solvent, an amount of rubber and an amount of resin and concentrating the plant material free miscella to less than the original volume by evaporating the extraction solvent, and adding additional acetone to precipitate rubber.

8. The method of claim 7, wherein the plant material is dried to a moisture content of between about 30%-36%.

9. The method of claim 1, wherein the at least first grind comprises a first grind performed using a first grind ⅜ inch screen and at least a second grind, the second grind is performed using a second grind ⅛ inch or smaller screen.

10. The method of claim 9, wherein the second grind is performed using a second grind ⅜ inch or smaller screen and the period of dwell time is 2 to 4 hours.

11. (canceled)

12. The method of claim 2, wherein the antioxidant is added before the at least first grind.

13. The method of 2, wherein the antioxidant is added before a second grind and after a chopping step, wherein the feedstock is cut into pieces prior to grinding.

14. (canceled)

15. The method of claim 2, wherein the antioxidant is added to the feedstock at a rate of between 2 and 4 parts antioxidant per hundred parts of expected rubber.

16. The method of claim 1, wherein the antioxidant comprises a phenylenediamine, optionally a dithiocarbamate is added or a combination thereof.

17. The method of claim 16, wherein the antioxidant comprises at least SANTOFLEX 134.

18. The method of claim 16, wherein BUTYL ZYMATE is added at between 0.01 part per hundred to about 0.1 part per hundred.

19. The method of claim 6, wherein the heat applied to the miscella is between 28° C. and 49° C.; more preferably between 30° C. and 48° C.; and most preferably between 37° C. and 46° C.

20. The method of claim 1, wherein the extraction solvent is pentane acetone.

21. The method of claim 20, wherein the extraction solvent is in a ratio of about 76 to 82 parts pentane to 17 to 24 parts acetone by weight, most preferably about 79 parts pentane and about 21 parts acetone.

22. The method of claim 1, wherein the rubber extracted has a molecular weight of at least 1,700,000.

23-24. (canceled)

25. An extracted guayule rubber comprising a molecular weight of at least 1.7 million (M) grams/mole, volatiles of less than about 0.30%, and a plastic retention index (PRI) of at least about 38.

26-39. (canceled)
